(19) United States
(12) Patent Application Publication
(10) Pub. No.: US 2002/0073553 A1
(43) Pub. Date: Jun. 20, 2002

(54) Utensil assembly

(76) Inventor: Mei Yang, Chang Hua City (TW)

Correspondence Address: CHARLES E. BAXLEY, ESQUTRE, 5 Floor, 59 John Street, New York, NY, 10038, US

(21) Appl. No.: 09/736,578

(22) Filed: Dec. 15, 2000

(51) Int. Cl. A47J 43/28

(52) U.S. Cl. 30/150; 30/151; 30/322; 30/326

(57) ABSTRACT

A utensil assembly includes a body having two utensil portions respectively connected to two ends of the body. Two first engaging members are located on each of two sides of the body. Two receptacles are respectively and removably mounted to the two utensil portions and each receptacle has a second engaging member so as to engage with the first engaging members. Each receptacle has a tongue extending from a close end thereof and two third engaging member are located on two sides of each tongue. The two receptacles can be connected to be a shaft by engaging the third engaging members of one receptacle with the second engaging members of the other receptacle.

### FIELD OF THE INVENTION

The present invention relates to a utensil assembly having a fork and a spoon on two ends thereof, and which can be received in two receptacles. The two receptacles can be connected with each other to become a long shaft.

### BACKGROUND OF THE INVENTION

A conventional utensil receptacle known to applicant is disclosed in U.S. Pat. No. 5,261,560 to Wang and the utensil receptacle is shown in FIGS. 6 and 7 wherein a fork 11 and a spoon 12 are respectively pivotally connected to an inside of a first cover 102 of a box 10, and a second cover 101 is hinged to the first cover 102. The fork 11 and the spoon 12 can be extended from two ends of the box 10. However, the length of the box 10 is not long enough so that the user's fingers may contact food. The fork 11 and the spoon 12 are riveted to the cover 102 so that the rivet portions could be loosened after the utensils are used for a period of time.

### SUMMARY OF THE INVENTION

In accordance with one aspect of the present invention, there is provided a utensil assembly and comprising a body having two utensil portions respectively connected to two ends of the body. Two first engaging members are located on each of two sides of the body. Two receptacles each have an open end and a close end, and the two utensil portions are respectively received in two receptacles via the respective open ends. Each receptacle has a second engaging member on each of two inner sides thereof. The first engaging members are disengagably connected to the second engaging member. Each receptacle has a tongue extending from the close end thereof and two third engaging member are located on two sides of each tongue. The third engaging member of one of the two receptacles are disengagably connected to the second engaging members of the other receptacle when the tongue of one of the receptacles is engaged with the open end of the other receptacle.

The primary object of the present invention is to provide a utensil assembly wherein the fork and the spoon can be received in two respective receptacles and the receptacles can be connected to become shaft.

These and farther objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is an exploded view to show a utensil assembly of the present invention;

FIG. 2 is an exploded view to show the utensil assembly of the present invention wherein two caps are connected to the body;

FIG. 3 is a perspective view to show the utensil assembly of the present invention;

FIG. 4 is a perspective view to show the utensil assembly of the present invention wherein the two receptacles are connected to be a shaft;

FIG. 5 is a perspective view to show the utensil assembly of the present invention wherein a ring is connected to the two receptacles are connected to be a shaft;

FIG. 6 is a perspective view to show a conventional utensil receptacle which is opened, and

FIG. 7 is a perspective view to show the conventional utensil receptacle which is closed.

### DETAILED DESCRIPTION OF THE PREFERRED EMBODIMENT

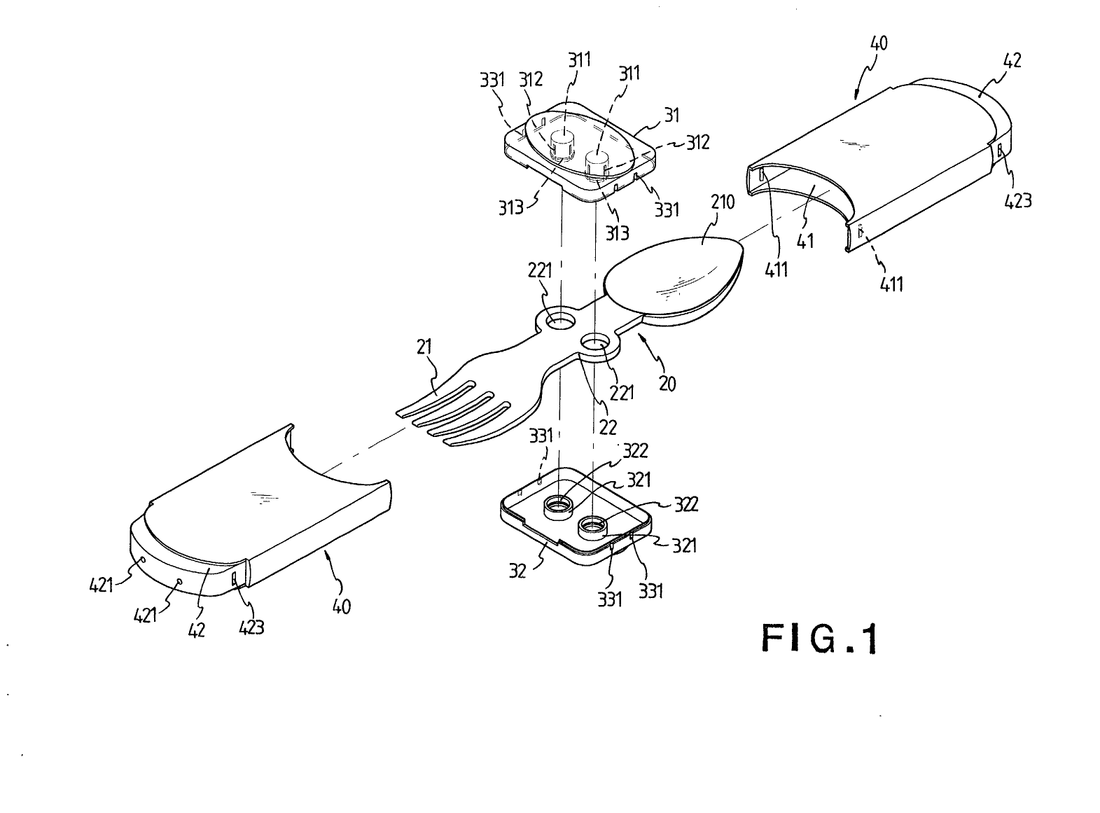

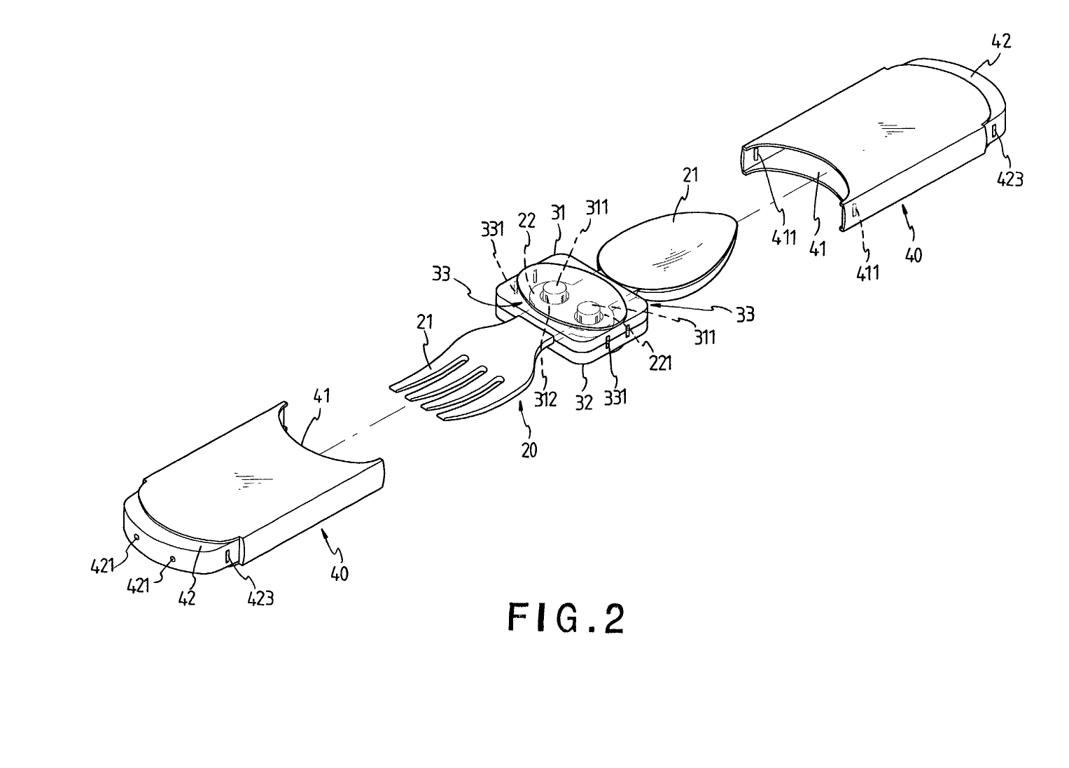

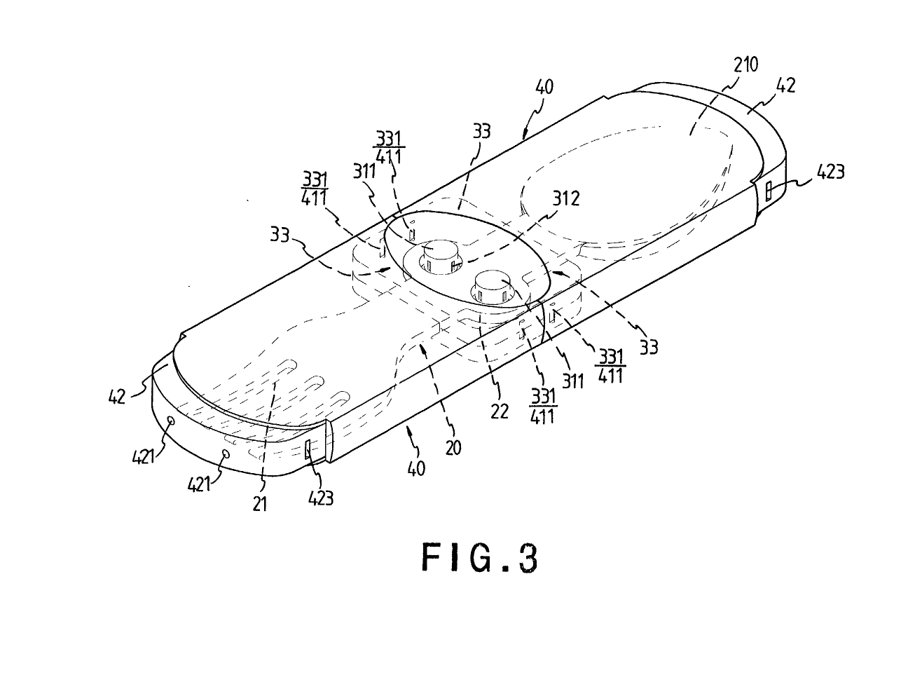

Referring to FIGS. 1 to 3, the utensil assembly of the present invention comprises a body 20 having two utensil portions 21 which are a fork 21 and a spoon 210 respectively connected to two ends of the body 20. Two holes 221 are defined through a mediate portion 22 of the body 20.

A first cap 31 has two insertion tubes 311 extending from a surface thereof and a second cap 32 has two receiving tubes 321 extending from a surface thereof. The two insertion tubes 311 extend through the holes 221 and are engaged with the receiving tubes 321. Two first engaging members 331 are located on two sides of each of the first cap 31 and the second cap 32. Each of the insertion tubes 311 has a plurality of slits 312 defined longitudinally therein and opens to a distal end of the insertion tube 311 so as to easily insert into the receiving tubes 321. Each of the insertion tubes 311 has an annular flange 313 extending radially outward from a distal end thereof, and each of the receiving tubes 321 has a groove 322 defined in an inner periphery thereof so that when the insertion tubes 311 inserted in the receiving tubes 321, the annular flanges 313 are engaged with the grooves 322.

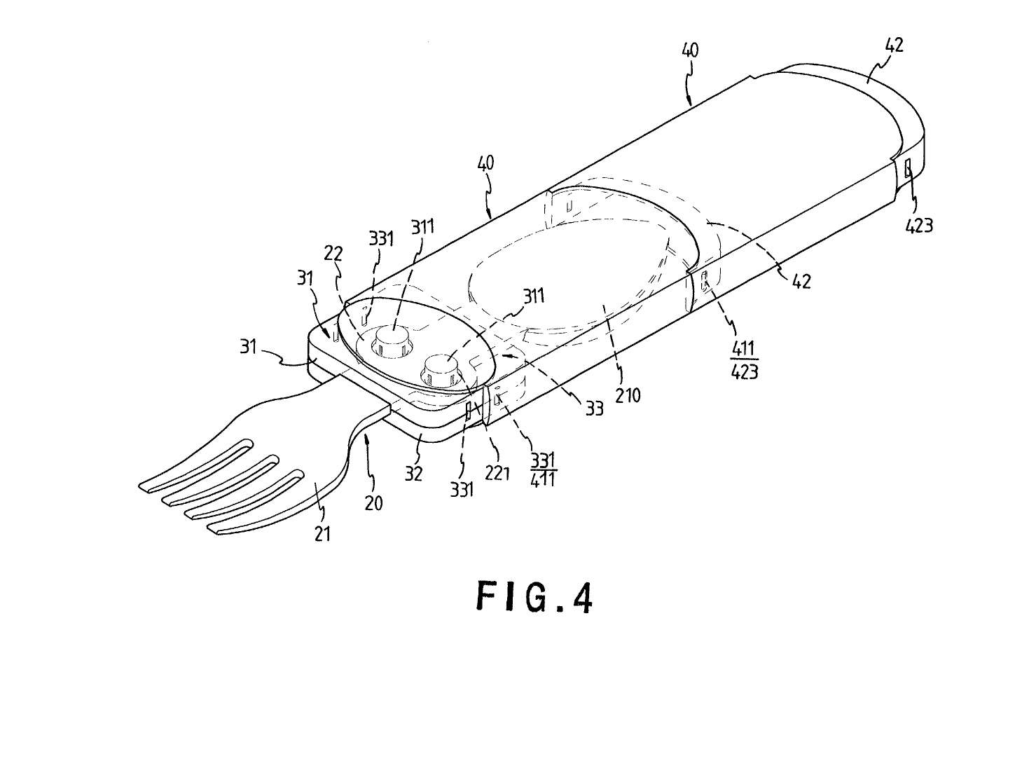

Two receptacles 40 each have an open end 41 and a close end. The two utensil portions 21 are respectively received in two receptacles 40 via the respective open ends 41 and each receptacle 40 has a second engaging member 411 on each of two inner sides thereof. The first engaging members 331 on the first cap 31 and the second cap 32 are disengagably connected to the second engaging member 411 when the two utensil portions 21, 210 are received in the two receptacles 40. Each receptacle 40 has a tongue 42 extending from the close end thereof and two third engaging member 423 are located on two sides of each tongue 42. As shown in FIG. 4, when the tongue 42 of one of the receptacles 40 is engaged with the open end of the other receptacle 40, the third engaging members 423 of one of the two receptacles 40 are disengagably connected to the second engaging members 411 of the other receptacle 40 so as to become a long shaft. By this way, the user can use either the fork 21 or the spoon 210 with a longer shaft.

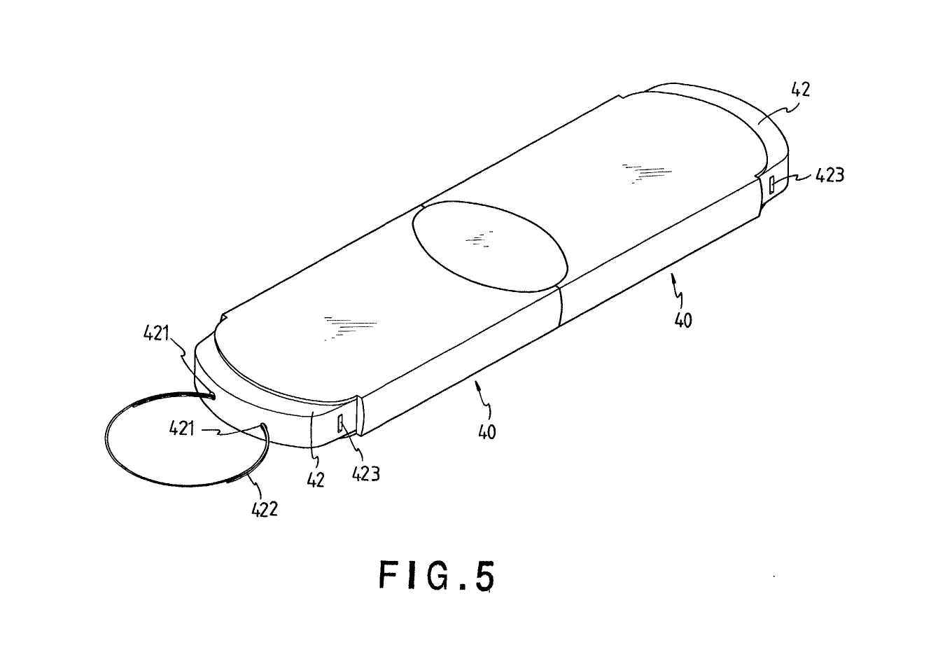

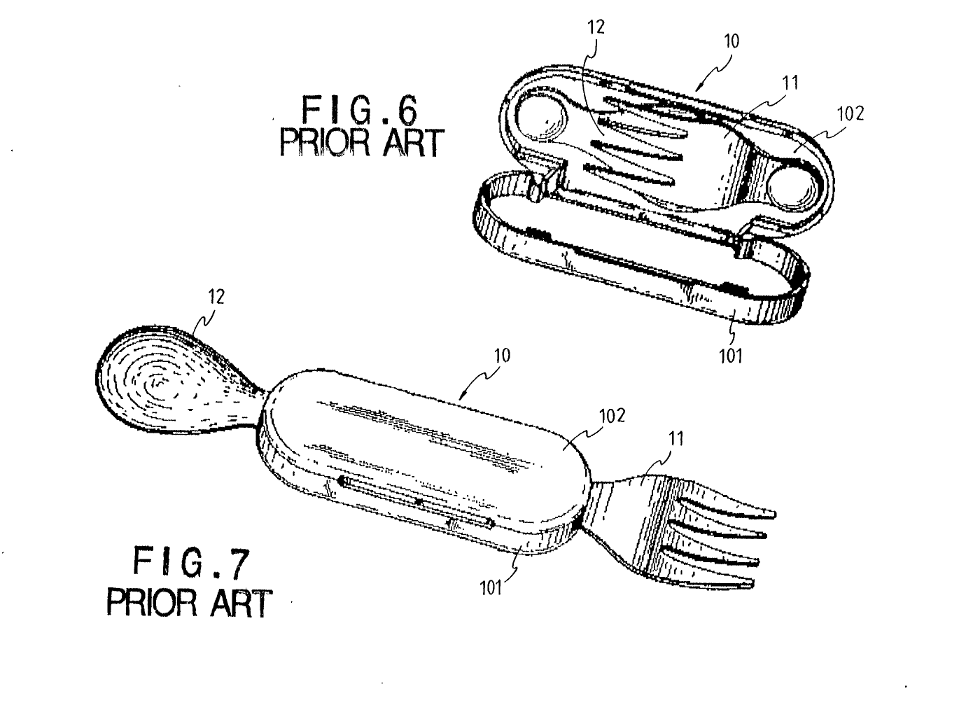

Referring to FIG. 5 wherein two apertures 421 are defined through each of the tongues 42 of the two receptacles 40. The apertures 421 provide a good ventilation feature for the utensil portions 21, 210 and a ring 422 or the like may extend through the two apertures 421 to hang the utensil assembly.

While we have shown and described various embodiments in accordance with the present invention, it should be clear to those skilled in the art that further embodiments may be made without departing from the scope and spirit of the present invention.

What is claimed is:

1. A utensil assembly comprising:
a body having two utensil portions respectively connected to two ends of said body, two first engaging members located on each of two sides of said body, and
two receptacles each having an open end and a close end, said two utensil portions respectively received in two receptacles via said respective open ends and each receptacle having a second engaging member on each of two inner sides thereof, said first engaging members disengagably connected to said second engaging member, each receptacle having a tongue extending from said close end thereof and two third engaging member located on two sides of each tongue, said third engaging members of one of said two receptacles 40 disengagably connected to said second engaging members of the other receptacle when said tongue of one of said receptacles is engaged with said open end of the other receptacle.

2. The utensil assembly as claimed in claim 1 further comprising two holes defined through said body, a first cap having two insertion tubes extending from a surface thereof and a second cap having two receiving tubes extending from a surface thereof, said two insertion tubes extending through said holes and engaged with said receiving tubes.

3. The utensil assembly as claimed in claim 2, wherein said first engaging members located on two sides of said first cap.

4. The utensil assembly as claimed in claim 2, wherein each of said insertion tubes having an annular flange extending radially outward from a distal end thereof, each of said receiving tubes having a groove defined in an inner periphery thereof so that when said insertion tubes inserted in said receiving tubes, said annular flanges are engaged with said grooves.

5. The utensil assembly as claimed in claim 2, wherein each of said insertion tubes has a plurality of slits defined longitudinally therein and opens to a distal end of said insertion tube.

6. The utensil assembly as claimed in claim 1 further comprising two apertures defined through each of said tongues of said receptacles.
